(19) United States
(12) Patent Application Publication
(10) Pub. No.: US 2004/0249685 A1
(43) Pub. Date: Dec. 9, 2004

(54) Seat reservation system and process

(76) Inventor: Craig Raymond Douglas, Lysterfield (AU)

Correspondence Address: MCKEE, VOORHEES & SEASE, P.L.C., 801 GRAND AVENUE, SUITE 3200, DES MOINES, IA, 50309-2721, US

(21) Appl. No.: 10/490,843

(22) PCT Filed: Sep. 26, 2002
(86) PCT No.: PCT/AU02/01319

(30) Foreign Application Priority Data
Sep. 28, 2001 (AU) PR 8018

(51) Int. Cl. G06F 17/60

(52) U.S. Cl. 705/5

(57) ABSTRACT

A seat reservation process, the process including the steps of: accepting reservation requests for available seats for an event; offering to customers an option to book a seat having one or more empty seats adjacent thereto on payment of a premium or agreeing to pay a premium or other consideration; terminating the reservation of requests for seats at a predetermined time: determining, after the step of terminating the reservation of requests for seats, if there are empty seats for the event; and if there are empty seats available for the event, allocating seats having empty seats adjacent thereto to those customers who have paid or have agreed to pay said premium or other consideration.

Some aspect of seat allocation at events, such as aircraft flights, bus trips, boat trips, theatre performances or sporting events are currently managed in an ad hoc fashion, and a traveller or attendee, as the case may be, can experience significant discomfort if they are seated next to a physically large or disruptive neighbour in the adjacent seat. This situation is exacerbated if a number of such people are seated in close proximity to the traveller or attendee. Consequently, the physical and social characteristics of one's seating neighbours, and in particular the presence or absence of such neighbours, can make the difference between an enjoyable experience or a profoundly uncomfortable one. Consequently, patrons prefer to be seated with at least one empty seat next to them so that they have more room and are not so crowded or otherwise disturbed.

It is desired, therefore, to provide a seat reservation process and system that alleviate one or more of the above difficulties, or at least provide a useful alternative to existing seat reservation processes and systems.

According to the present invention there is provided a seat reservation process, the process including the steps of:

accepting reservation requests for available seats for an event;

offering to customers an option to book a seat having an empty seat adjacent thereto on payment of a premium or agreeing to pay a premium or other consideration;

terminating the reservation of requests for seats at a predetermined time;

determining, after said step of terminating the reservation of requests for seats, if there are empty seats for the event; and

if there are empty seats available for the event, allocating seats having empty seats adjacent thereto to those customers who have paid or have agreed to pay said premium or other consideration.

Normally, the step of terminating the reservation of requests for seats occurs prior to the commencement of the event, but this need not always be the case.

The process may include the steps of making a conditional allocation of an empty seat and confirming allocation of empty seats after said step of terminating the reservation of requests for seats.

In the case where the seat reservation process is in relation to aircraft flights, the process may include the steps of analysing available seats and the pattern of seat sales just prior to closure of the flight and making conditional allocation of empty seats based upon said analysis.

The process may include the steps of determining if there are sufficient empty seats available for those customers requesting them and confirming allocation of empty seats according to a predetermined priority or randomly.

The present invention also provides, in an airline seat reservation process, an empty seat allocation process which includes the steps of:

allocating a first seat to a passenger for a flight; and

allocating a second seat to the passenger adjacent to the first seat if the passenger provides or agrees to provide consideration for the allocation of said second seat.

The event may be an aircraft flight, bus journey, ferry ride or other form of transport where passengers are assigned fixed seating. The event may also be a theatre performance, sporting event or other form of entertainment where patrons are assigned fixed seating.

The present invention also provides a seat reservation system having components for executing the steps of any one of the above processes.

The present invention also provides program code for executing the steps of any one of the above processes.

The present invention also provides a computer readable storage medium having stored thereon program code for executing the steps of any one of the above processes.

The present invention also provides a seat reservation system, including a seat reservation module for generating reservation data for reserving a seat for an event and one or more empty seats adjacent thereto on payment of a premium or agreeing to pay a premium or other consideration, and an empty seat allocator for allocating empty seats on the basis of said reservation data.

The invention will now be further described as it can be implemented to an airline seat reservation system. It is to be understood, however, that the principles of the invention can also be applied in other areas, as indicated above.

Preferred embodiments of the present invention are hereinafter described, by way of example only, with reference to the accompanying drawings, wherein:

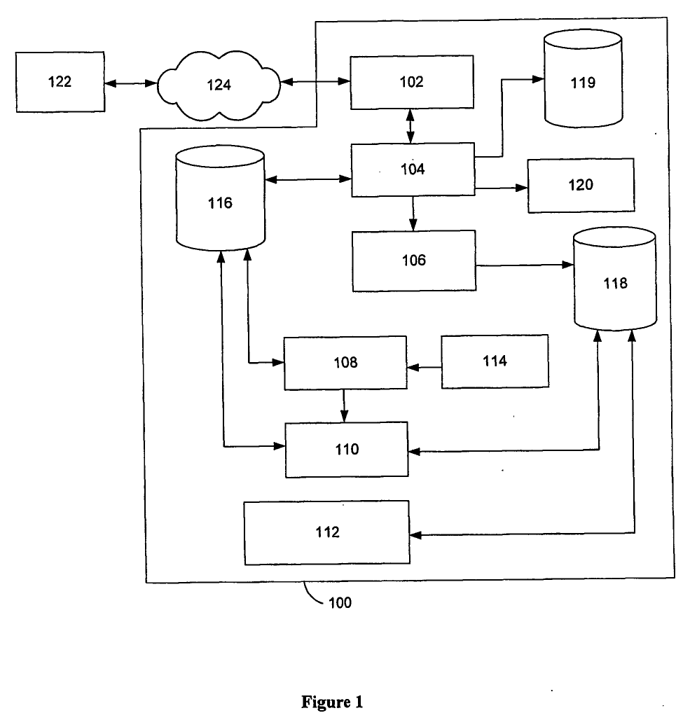

FIG. 1 is a block diagram of a preferred embodiment of a reservation system;

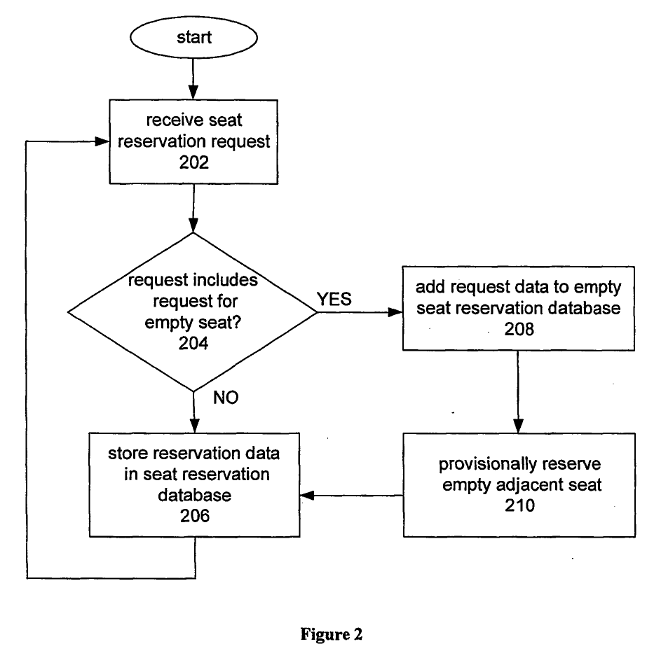

FIG. 2 is a flow diagram of a seat reservation process executed by the system;

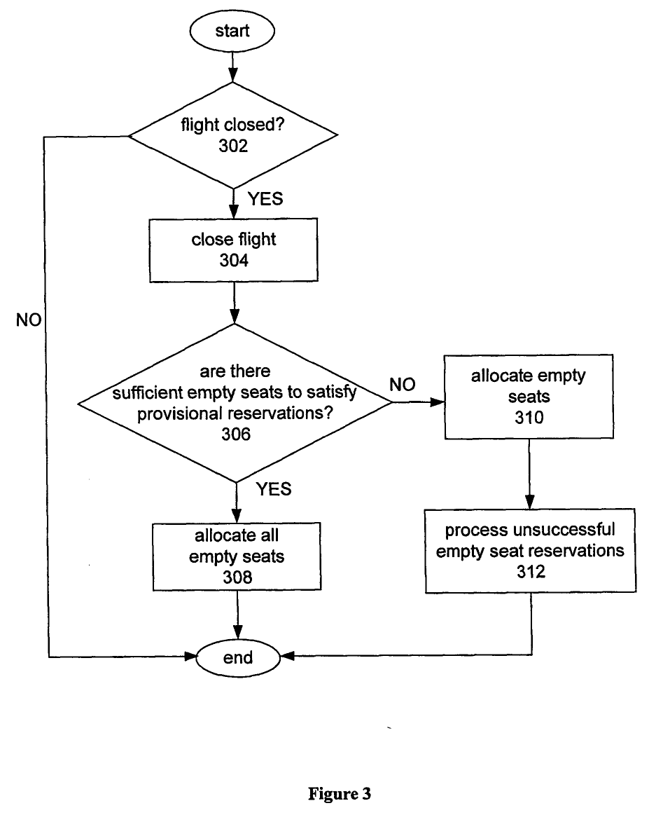

FIG. 3 is a flow diagram of an empty seat allocation process executed by the system;

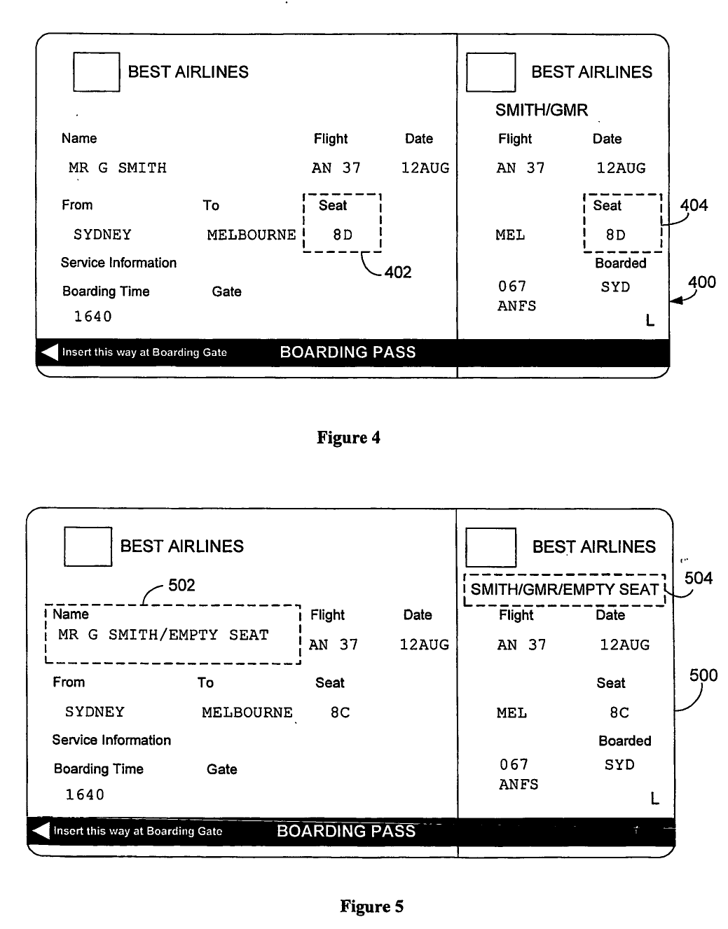

FIG. 4 is a schematic view of a boarding pass suitable for passenger travel;

FIG. 5 is a schematic view of a boarding pass suitable for allocation of an empty seat; and

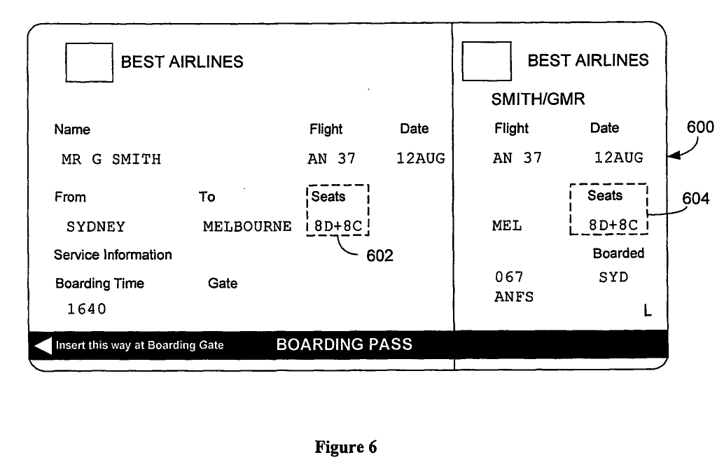

FIG. 6 is a schematic view of a boarding pass suitable for a passenger seat and an allocated empty seat.

As shown in FIG. 1, a seat reservation system includes seat reservation modules 102 to 112, comprising a terminal interface 102, a seat reservation module 104, an empty seat reservation database 106, a flight status monitor 108, an empty seat allocator 110, an unsuccessful reservation processor 112, a timer 116, a seat reservation database 116, an empty seat reservation database 118, a standby customer database 119, and a printer 120. The seat reservation system can be connected to one or more reservation terminals 122 via a communications network 124, such as a dedicated communications line or a public network, such as the Internet. The reservation system executes a seat reservation process and an empty seat allocation process, as described below, that allow passengers to book or reserve a seat on an airplane and to provisionally reserve an empty seat adjacent to the booked seat in exchange for a premium on the normal ticket price.

Various forms of airline seat reservation systems are well known and documented. Examples include those disclosed in U.S. Pat. No. 5,270,921, U.S. Pat. No. 6,134,534 and the various publications referred to in those specifications. The process and system of the invention can be implemented by inclusion of additional steps in those systems in order to provide for selective allocation of empty seats. In the described embodiment, the seat reservation system is a standard computer system such as a high-end server manufactured by IBM™, and the seat reservation process and the empty seat allocation process executed by the system are implemented as the seat reservation modules 102 to 112 of the reservation system, being software modules stored on non-volatile storage associated with the server. However, it will be apparent to those skilled in the art that at least parts of the seat reservation and allocation processes can alternatively be implemented by dedicated hardware components, such as application-specific integrated circuits (ASICs).

The reservation system 100 can be accessed by a travel agent or a customer via the network 124, by using the terminal 122. When the customer or travel agent decides to book a seat, the customer is presented with the option of paying a premium to reserve one or more empty seats adjacent to the booked seat. The premium can be a fixed sum, such as $100, or a percentage of the fare or sector price. Typically, passengers are prepared to pay up to about 20% or 30% more than a standard fare in order to have an empty seat allocated to them. Normally, the premium on the standard fare is paid at the time when payment is made for the seat reservation. Alternatively, the premium can be paid after the normal ticket fare has been paid, at check in or prior to closing of the flight. Payment can be effected by cash, account or credit card in the usual way. Alternatively, some airlines can allow frequent flyer points to be exchanged for an empty seat allocation. It will be apparent that other forms of customer loyalty bonus arrangements could be employed in consideration for allocation of empty seats.

The reservation system executes a seat reservation process, as shown in FIG. 2. The seat reservation process begins at step 202 when a seat reservation request is received by the seat reservation module 104 via the terminal interface 102. At step 204, the seat reservation module 104 determines whether the request includes a request for a provisional reservation of one or more empty seats adjacent to the reserved seat. If not, then the seat reservation module 104 makes a seat reservation for a single seat in the standard manner, by creating a seat reservation record in the seat reservation database 116. Otherwise, the empty seat reservation module 106 stores a provisional reservation record in the empty seat reservation database 118 at step 208. The provisional reservation record includes the flight details, the details of the customer making the reservation, and the number of empty adjacent seats requested. This constitutes a provisional reservation of one or more empty seats to the passenger, and a request for the reserved seat and the provisionally reserved empty seat or seats is then sent to the seat reservation module 104 for processing. The request for one or more empty seats can be treated as one or more dummy passengers to be seated next to the reserved seat. This requires relatively minor modification of a standard seat reservation module. Alternatively, the empty seat allocation request can be implemented as a flag or other indicator which is associated with the reserved seat.

Customers can continue to reserve seats and request empty seats until either the flight is full, or the flight closes. In either case, further prospective passengers are added to the standby customer database 119, which can alternatively be the empty seat reservation database 118. At periodic intervals, as initiated by the timer 114, the seat reservation system executes an empty seat allocation process, as shown in FIG. 3. This process is executed at periodic intervals in response to the timer 114, and begins at step 302 when the flight status monitor 108 determines whether the flight should be closed. This is usually determined on the basis of the current time and the scheduled flight time, and the flight is closed when the time remaining prior to the scheduled flight time is less than a predetermined period. When this occurs, the flight is closed at step 304 by setting a flag in the seat reservation database 116. At step 306, the empty seat allocator 110 checks the seat reservation database 116 and the empty seat reservation database 118 to determine whether the number of empty seats as indicated by the seat reservation database 116 is equal to or greater than the number of empty seat reservations for the flight in the empty seat reservation database 118. This can be determined by adding together the number of unreserved seats and the number of seats with either dummy passengers, or with flags set, depending upon how reserved empty seats are indicated in the seat reservation database 116. If there are sufficient empty seats to meet the provisional reservations, then at step 308 the empty seat allocator 110 allocates empty seats to satisfy all of the empty seat reservation requests in the empty seat reservation database 118. This is achieved by updating the seat reservation database 116 to provide confirmed reservations for the empty seat or seats adjacent to the seat originally reserved by the passenger, as described above. These empty seats are associated with the customer details, and the dummy passengers or flags are removed.

If, on the other hand, there are not enough empty seats to satisfy all of the empty seat requests in the empty seat reservation database 118, then at step 310 the empty seat allocator 110 allocates all of the available empty seats to at least some of the passengers on the empty seat reservation database 118. The allocation of empty seats is carried out according to a predetermined priority. It will be apparent that the empty seats can be allocated in various ways. For example, the allocation can be according to the time in which requests for empty seats were created in the empty seat reservation database 118, or by membership of airline loyalty systems. Alternatively, the empty seats can be allocated randomly.

At step 312, the unsuccessful reservation processor 112 processes the unsuccessful provisional empty seat reservations in the empty seat reservation database 118 to compensate those customers who requested a provisional reservation, but were not allocated a seat because insufficient empty seats were available. Customers can be compensated in a variety of ways. One way would be for the passenger to forfeit the premium. Another way would be to receive a credit for use on a future flight or to receive an award of frequent flyer points. Alternatively, the airline may refund the premium.

After confirmation of the allocation of empty seats, the seat reservation system 6 is preferably arranged to issue empty seat boarding passes to those passengers who have been successful in obtaining allocation of an empty seat. In accordance with the invention, it is preferred to provide the passenger who has obtained an allocated empty seat some form of evidence that the empty seat has been allocated to him. The main purpose for this would be some form of evidence available to the passenger having the empty seat that the empty seat has in fact been allocated to him or her. Otherwise, other passengers may try to take the benefit of the empty seat. One way of providing tangible evidence of the allocation of the empty seat would be to issue a separate boarding pass in respect of the empty seat. Alternatively, a single boarding pass could be issued which is in respect of two adjacent seats.

FIG. 4 shows a normal boarding pass 402 in which the allocated seat number is printed in seat number fields 404 and 406. FIG. 5 shows a second boarding pass 500 that is issued to the passenger for the allocated empty seat. The fact that the seat was an empty seat allocation is indicated by printing the words EMPTY SEAT after the passenger's name in the name fields 502 and 504. In the illustrated arrangement, seat 8C has been allocated to the passenger as the adjacent empty seat.

FIG. 6 illustrates an alternative arrangement in which a single boarding pass 600 is issued to the passenger in respect of his or her seat and empty seat. In this case the seat number fields are printed in such a way as to indicate that two seats have been allocated. In the illustrated arrangement, this is achieved by printing the letter “s” after the word “seat” and by printing seat numbers “8D+8C” in the seat number fields 602 and 604, as illustrated.

In an alternative embodiment, after provisional reservation details are stored in the empty seat reservation database 118, the empty seat allocator 110 generates a provisional allocation of an empty seat to the customer on the basis of the remaining empty seats in the seat reservation database 116 and the past history of late seat sales just prior to closure of the flight. That is, a provisional empty seat reservation is only generated if there are more empty seats available than the total of those remaining unreserved, those provisionally reserved, and the number expected to be reserved between the current time and the time the flight will close. A request for the seat reservation and the provisional empty seat reservation is then passed to the seat reservation module 104 for processing as described above. This provides a more certain indication to customers of the availability of one or more empty seats, and allows appropriate boarding passes to be issued well prior to closure of the flight. However, the empty seat reservations remain provisional until confirmed allocation is made after the flight closes.

It will be appreciated by those skilled in the art that the process and system of the invention provides a useful option for passengers and an opportunity for airlines to generate revenue from empty seats. The option of paying a premium for an allocated empty seat could be of particular advantage to certain classes of passengers, including business travellers, couples, claustrophobics, those travelling with infants, those who are obese or who have other disabilities.

The reference to any prior art in this specification is not, and should not be taken as, an acknowledgment or any form of suggestion that that prior art forms part of the common general knowledge in Australia.

Many modifications will be apparent to those skilled in the art without departing from the spirit and scope of the invention.

1. A seat reservation process, the process including the steps of:
accepting reservation requests for available seats for an event;
offering to customers an option to book a seat having one or more empty seats adjacent thereto on payment of a premium or agreeing to pay a premium or other consideration;
terminating the reservation of requests for seats at a predetermined time;
determining, after said step of terminating the reservation of requests for seats, if there are empty seats for the event; and
if there are empty seats available for the event, allocating seats having empty seats adjacent thereto to those customers who have paid or have agreed to pay said premium or other consideration.

2. A process as claimed in claim 1 including the steps of making a conditional allocation of an empty seat and confirming allocation of empty seats after said step of terminating the reservation of requests for seats.

3. A process as claimed in claim 1 wherein the seat reservation process is for reservation of aircraft passenger seats on an aircraft flight.

4. A process as claimed in claim 3 wherein the process includes the steps of analyzing available seats and the pattern of seat sales just prior to closure of the flight and making conditional allocation of empty seats based upon said analysis.

5. A process as claimed in claim 3 wherein the process includes the steps of determining if there are sufficient empty seats available for those customers requesting them and confirming allocation of empty seats according to a predetermined priority or randomly.

6. In an airline seat reservation process, an empty seat allocation process which includes the steps of:
allocating a first seat to a passenger for a flight; and
allocating a second seat to the passenger adjacent to the first seat if the passenger provides or agrees to provide consideration for the allocation of said second seat.

7. A process as claimed in claim 6 including the step of determining if there are available any empty seats on the passenger's flight or a sector thereof; and allocating said second seat to the passenger for the flight or a sector thereof if there are empty seats available.

8. A process of claimed in claim 6 wherein said step of providing or agreeing to provide consideration includes the step of the passenger paying or agreeing to pay a premium for the allocation of the second seat.

9. A process as claimed in claim 6 wherein said step of providing or agreeing to provide consideration includes the step of the passenger redeeming or agreeing to redeem frequent flyer points, miles or kilometres.

10. A process as claimed in claim 8 wherein, if the passenger has paid a premium for allocation of a second seat but no empty seats are available, the process includes the step of retaining the premium or providing a credit to the passenger in respect of all or part of the premium.

11. A process as claimed in claim 9 wherein if the passenger has redeemed frequent flyer points, miles or kilometres but no empty seats are available, the process includes the step of issuing a credit of frequent flyer points, miles or kilometres equal to all or part of those redeemed by the passenger.

12. A process as claimed in claim 7 including the steps of maintaining an empty seat database of empty seats for a flight or a sector thereof and wherein said step of determining if there are available any empty seats includes the step of interrogating said database.

13. A process as claimed in claim 12 including the steps of maintaining a request database of requests for empty seats for a flight or sector thereof and interrogating the request database and comparing the number of requested empty seats to the number of available empty seats prior to allocating said second seats to the passengers.

14. A process as claimed in claim 13 wherein if said step of comparing the number of requested empty seats to the number of available empty seats determines that there are insufficient empty seats for passengers requesting them, the process includes the step of allocating the second seats to passengers according to a predetermined priority or randomly.

15. A process as claimed in claim 14 wherein the predetermined priority of allocating second seats to passengers is consistent with an airline loyalty program.

16. A process as claimed in claim 6 including the step of issuing to the passenger a first boarding pass in respect of the first seat and a second boarding pass in respect of the second seat.

17. A process as claimed in claim 6 including the step of issuing to the passenger a boarding pass which is imprinted to show that the first and second seats have been allocated to the passenger.

18. A seat reservation system having components for executing the steps of the process of claim 1.

19. A computer readable storage medium having stored thereon program code for executing the step of the process claimed in claim 1.

20. A seat reservation system, including a seat reservation module for generating reservation data for reserving a seat for an event and one or more empty seats adjacent thereto on payment of a premium or agreeing to pay a premium or other consideration, and an empty seat allocator for allocating empty seats on the basis of said reservation data.

21. A seat reservation system as claimed in claim 20, including an unsuccessful reservation processor for processing unsuccessful provisional reservations for empty seats.
